(19) United States
(12) Patent Application Publication
(10) Pub. No.: US 2009/0242060 A1
(43) Pub. Date: Oct. 1, 2009

(54) Fluid transportation device having multiple double-chamber actuating structrures

(75) Inventors: Shih Chang Chen, Hsin-Chu (TW); Ying Lun Chang, Hsin-Chu (TW); Rong Ho Yu, Hsin-Chu (TW); Shih Che Chiu, Hsin-Chu (TW); Tsung Pat Chou, Hsin-Chu (TW)

Correspondence Address: BACON & THOMAS, PLLC, 625 SLATERS LANE, FOURTH FLOOR, ALEXANDRIA, VA, 22314-1176, US

(73) Assignee: Microjet Technology Co., Ltd., Hsin-Chu (TW)

(21) Appl. No.: 12/382,950

(22) Filed: Mar. 27, 2009

(30) Foreign Application Priority Data
Mar. 31, 2008 (CN) 200810090955. X

(51) Int. Cl. F15C 3/04; F16K 11/20

(52) U.S. Cl. 137/814; 137/597

(57) ABSTRACT

A fluid transportation device includes a flow-gathering module and multiple double-chamber actuating structures. The flow-gathering module includes two surfaces opposed to each other, multiple first flow paths and multiple second flow paths running through the two surfaces, an inlet channel arranged between the two surfaces and communicated with the multiple first flow paths, and an outlet channel arranged between the two surfaces and communicated with the multiple second flow paths. The multiple double-chamber actuating structures are arranged on the flow-gathering module side by side. Each double-chamber actuating structure includes a first chamber and a second chamber symmetrically arranged on the two surface of the flow-gathering module. Each of the first chamber and the second chamber includes a valve cap arranged over the flow-gathering module, a valve membrane arranged between the flow-gathering module and the valve cap, and an actuating member having a periphery fixed on the valve cap.

### FIELD OF THE INVENTION

The present invention relates to a fluid transportation device, and more particularly to a fluid transportation device having multiple double-chamber actuating structures.

### BACKGROUND OF THE INVENTION

Nowadays, fluid transportation devices used in many sectors such as pharmaceutical industries, computer techniques, printing industries, energy industries are developed toward miniaturization. The fluid transportation devices used in for example micro pumps, micro atomizers, printheads or industrial printers are very important components. Consequently, it is critical to improve the fluid transportation devices.

FIG. 1 is a schematic view of a conventional micro pump. The conventional micro pump 10 principally comprises a valve seat 11, a valve cap 12, a valve membrane 13, a micro actuator 14 and a cover plate 15. The valve membrane 13 includes an inlet valve structure 131 and an outlet valve structure 132. The valve seat 11 comprises an inlet channel 111 and an outlet channel 112. A pressure cavity 123 is formed between the valve cap 12 and the micro actuator 14. The valve membrane 13 is arranged between the valve seat 11 and the valve cap 12.

When a voltage is applied on both electrodes of the micro actuator 14, an electric field is generated. The electric field causes downward deformation of the micro actuator 14. In a case that the micro actuator 14 is subject to upwardly deformation in the direction X, the volume of the pressure cavity 123 is expanded to result in a suction force. Due to the suction force, the inlet valve structure 131 of the valve membrane 13 is opened and thus the fluid is transported into the pressure cavity 123 through the inlet channel 111 of the valve seat 11, the inlet valve structure 131 of the valve membrane 13 and the inlet valve channel 121 of the valve cap 12. On the other hand, if the micro actuator 14 is subject to downward deformation in a direction opposite to the direction X, the volume of the pressure cavity 123 is shrunk to result in an impulse. The impulse is exerted on the inlet valve structure 131 and the outlet valve structure 132 of the valve membrane 13, so that the outlet valve structure 132 is opened. When the outlet valve structure 132 is opened, the fluid is exhausted from the pressure cavity 123 to the outside of the micro pump 10 through the outlet valve channel 122 of the valve cap 12, the outlet valve structure 132 of the valve membrane 13 and the outlet channel 112 of the valve seat 11. Meanwhile, a fluid transporting cycle is completed.

Although the conventional micro pump 10 is effective for transporting a fluid, there are still some drawbacks. For example, the conventional micro pump 10 has a single actuator, a signal pressure cavity, a single flow path, a single inlet/outlet and a single pair of valve structures. For increasing the flow rate of the micro pump 10, an additional coupling mechanism is required to connect multiple micro pump units, which are stacked. Since the use of the coupling mechanism is very costly and the overall volume of multiple micro pump units is very bulky, the final product fails to meet the miniaturization demand.

For increasing the flow rate and reducing the overall volume, there is a need of providing a fluid transportation device having multiple double-chamber actuating structures so as to obviate the drawbacks encountered from the prior art.

### SUMMARY OF THE INVENTION

As previously described, an additional coupling mechanism is required to connect multiple micro pump units and stack the micro pump units in order to increase the flow rate of the conventional micro pump. The use of the coupling mechanism is very costly and the overall volume of multiple micro pump units is very bulky, the final product fails to meet the miniaturization demand. For increasing the flow rate and reducing the overall volume, the present invention provides a fluid transportation device having multiple double-chamber actuating structures.

In accordance with an aspect of the present invention, there is provided a fluid transportation device having multiple double-chamber actuating structures for transporting a fluid. The fluid transportation device includes a flow-gathering module and multiple double-chamber actuating structures. The flow-gathering module includes two surfaces opposed to each other, multiple first flow paths and multiple second flow paths running through the two surfaces, an inlet channel arranged between the two surfaces and communicated with the multiple first flow paths, and an outlet channel arranged between the two surfaces and communicated with the multiple second flow paths. The multiple double-chamber actuating structures are arranged on the flow-gathering module side by side. Each double-chamber actuating structure includes a first chamber and a second chamber symmetrically arranged on the two surface of the flow-gathering module. Each of the first chamber and the second chamber includes a valve cap arranged over the flow-gathering module, a valve membrane arranged between the flow-gathering module and the valve cap, and an actuating member having a periphery fixed on the valve cap.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic view of a conventional micro pump;

FIG. 2 is a schematic exploded view illustrating a fluid transportation device having multiple double-chamber actuating structures according to an embodiment of the present invention;

FIG. 3A is a schematic assembled view illustrating the fluid transportation device of FIG. 2;

FIG. 3B is a schematic cross-sectional view illustrating the flow-gathering module of the fluid transportation device shown in FIG. 3A and taken along the line A-A or the line a-a;

FIG. 3C is a schematic cross-sectional view illustrating the flow-gathering module of the fluid transportation device shown in FIG. 3A and taken along the line C-C;

FIG. 3D is a schematic cross-sectional view illustrating the flow-gathering module of the fluid transportation device shown in FIG. 3A and taken along the line B-B;

FIG. 4A is a schematic cross-sectional view illustrating the valve cap of the first chamber included in the first double-chamber actuating structure of the fluid transportation device shown in FIG. 3A and taken along the line A-A;

FIG. 4B is a schematic cross-sectional view illustrating the valve caps of the first chambers included in the first and second double-chamber actuating structures of the fluid transportation device shown in FIG. 3A and taken along the line C-C;

FIG. 4C is a schematic cross-sectional view illustrating the valve caps of the first chambers included in the first and second double-chamber actuating structures of the fluid transportation device shown in FIG. 3A and taken along the line B-B;

FIG. 5 is a schematic cross-sectional view illustrating the valve membrane of the first chamber included in the first double-chamber actuating structure of the fluid transportation device shown in FIG. 2;

FIG. 6A is a schematic cross-sectional view illustrating the fluid transportation device shown in FIG. 3A and taken along the line A-A, wherein the fluid transportation device is in a non-actuation status;

FIG. 6B is a schematic cross-sectional view illustrating the fluid transportation device shown in FIG. 6A, in which the volume of the pressure cavity is expanded;

FIG. 6C is a schematic cross-sectional view illustrating the fluid transportation device shown in FIG. 6A, in which the volume of the pressure cavity is shrunken;

FIG. 7A is a schematic cross-sectional view illustrating the fluid transportation device shown in FIG. 3A and taken along the line B-B;

FIG. 7B is a schematic cross-sectional view illustrating the fluid transportation device shown in FIG. 7A, in which the volume of the pressure cavity is expanded;

FIG. 7C is a schematic cross-sectional view illustrating the fluid transportation device shown in FIG. 7A, in which the volume of the pressure cavity is shrunken;

FIG. 8A is a schematic cross-sectional view illustrating the fluid transportation device shown in FIG. 3A and taken along the line C-C;

FIG. 8B is a schematic cross-sectional view illustrating the fluid transportation device shown in FIG. 8A, in which the volume of the pressure cavity is expanded; and

FIG. 8C is a schematic cross-sectional view illustrating the fluid transportation device shown in FIG. 8A, in which the volume of the pressure cavity is shrunken.

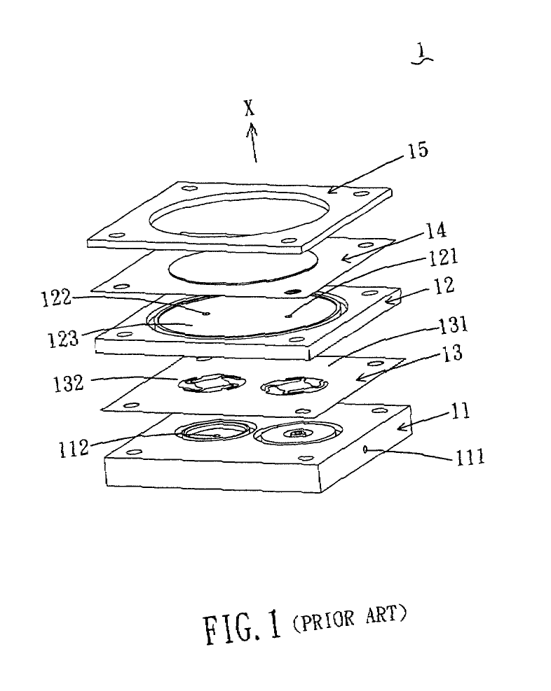

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

The fluid transportation device of the present invention includes a flow-gathering module and multiple double-chamber actuating structures. The multiple double-chamber actuating structures are symmetrically stacked on the flow-gathering module. The fluid transportation device of the present invention is capable of increasing flow rate and head without largely increasing the overall volume thereof. That is, the fluid transportation device of the present invention is feasible to the applications requiring high flow rate and high head.

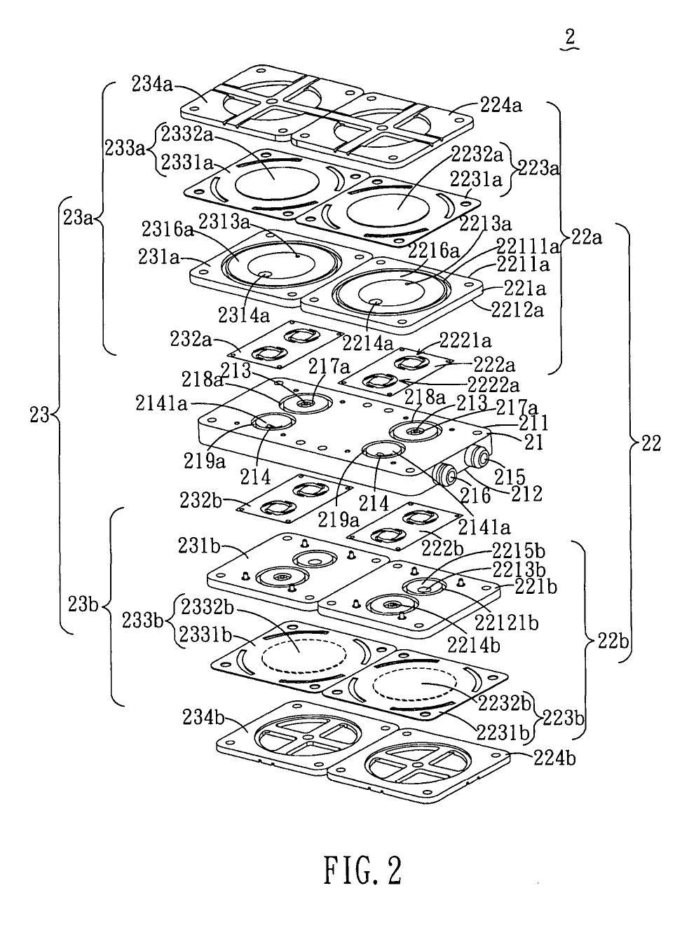

FIG. 2 is a schematic exploded view illustrating a fluid transportation device having multiple double-chamber actuating structures according to an embodiment of the present invention. The fluid transportation device 2 of the present invention comprises a flow-gathering module 21 and multiple double-chamber actuating structures. For clarification and brevity, only two double-chamber actuating structures are shown in the drawings. That is, the fluid transportation device 2 has a first double-chamber actuating structure 22 and a second double-chamber actuating structure 23. The first double-chamber actuating structure 22 and the second double-chamber actuating structure 23 are substantially identical. The number of the double-chamber actuating structures included in the fluid transportation device 2 of the present invention may be varied according to the practical requirements.

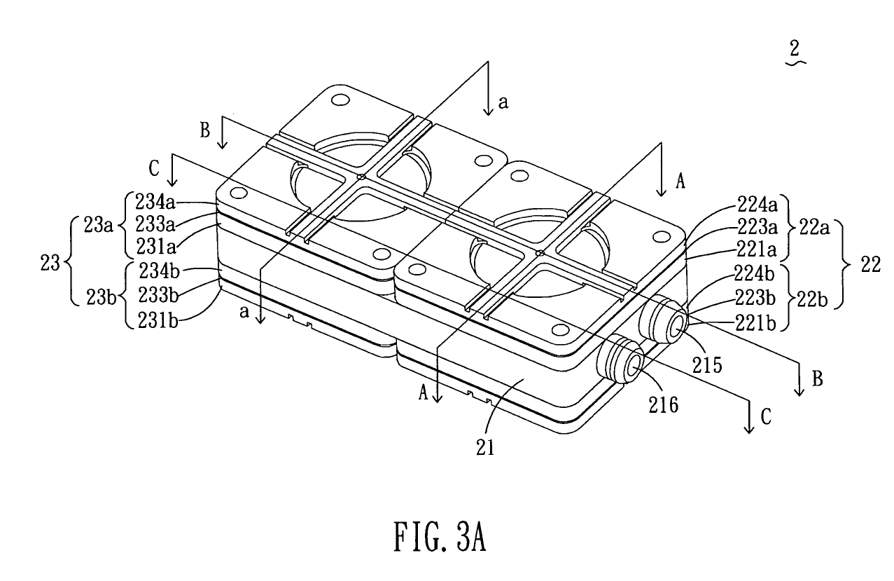

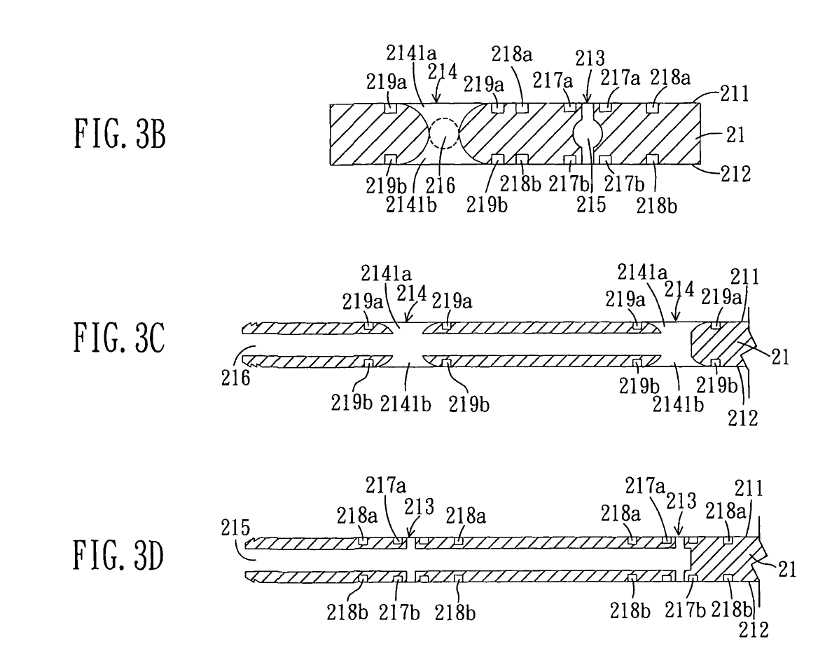

Each double-chamber actuating structure of the fluid transportation device 2 has two chambers at the upper side and the lower side, respectively. The double-chamber actuating structures are arranged on the flow-gathering module 21 side by side. FIG. 3A is a schematic assembled view illustrating the fluid transportation device of FIG. 2. Please refer to FIG. 2 and FIG. 3A. The first double-chamber actuating structure 22 includes a first chamber 22a and a second chamber 22b, which are respectively arranged on the first surface 211 and the second surface 212 of the flow-gathering module 21. The first chamber 22a has a valve cap 221a, a valve membrane 222a, an actuating member 223a and a cover plate 224a. The second chamber 22b has a valve cap 221b, a valve membrane 222b, an actuating member 223b and a cover plate 224b. The first chamber 22a and the second chamber 22b are mirror-symmetrical with respect to the flow-gathering module 21.

The second double-chamber actuating structure 23 includes a first chamber 23a and a second chamber 23b, which are respectively arranged on the first surface 211 and the second surface 212 of the flow-gathering module 21. The first chamber 23a has a valve cap 231a, a valve membrane 232a, an actuating member 233a and a cover plate 234a. The second chamber 23b has a valve cap 231b, a valve membrane 232b, an actuating member 233b and a cover plate 234b. The first chamber 23a and the second chamber 23b are mirror-symmetrical with respect to the flow-gathering module 21.

In this embodiment, the first double-chamber actuating structure 22 and the second double-chamber actuating structure 23 are arranged on the flow-gathering module 21 side by side. That is, the first chamber 22a of the first double-chamber actuating structure 22 and the first chamber 23a of the second double-chamber actuating structure 23 are arranged on the first surface 211 of the flow-gathering module 21 side by side. In addition, the second chamber 22b of the first double-chamber actuating structure 22 and the second chamber 23b of the second double-chamber actuating structure 23 are arranged on the second surface 212 of the flow-gathering module 21 side by side.

FIG. 3B is a schematic cross-sectional view illustrating the flow-gathering module of the fluid transportation device shown in FIG. 3A and taken along the line A-A or the line a-a. FIG. 3C is a schematic cross-sectional view illustrating the flow-gathering module of the fluid transportation device shown in FIG. 3A and taken along the line C-C. FIG. 3D is a schematic cross-sectional view illustrating the flow-gathering module of the fluid transportation device shown in FIG. 3A and taken along the line B-B. Please refer to FIG. 2, FIG. 3A, FIG. 3B, FIG. 3C, and FIG. 3D. The flow-gathering module 21 is substantially rectangular bar having the first surface 211 and the second surface 212, which are opposed to each other. The flow-gathering module 21 has multiple first flow paths, multiple second flow paths, an inlet channel 215 and an outlet channel 216. As shown in FIGS. 3B, 3C and 3D, the multiple first flow paths are multiple inlet branch flow paths 213 that vertically run through the first surface 211 and the second surface 212. The multiple second flow paths are multiple outlet confluent flow paths 214 that vertically run through the first surface 211 and the second surface 212. In other words, the openings of respective inlet branch flow paths 213 at the first surface 211 and the second surface 212 are coaxial. Similarly, the openings of respective outlet confluent flow paths 214 are coaxial. The inlet branch flow paths 213 and the outlet confluent flow paths 214 are independent from each other (see FIG. 3). The first surface 211 and the second surface 212 are communicated with each other through the inlet branch flow paths 213 and the outlet confluent flow paths 214.

Please refer to FIG. 3C and FIG. 3D again. The inlet channel 215 and the outlet channel 216 are pipelines between the first surface 211 and the second surface 212. The external flow is introduced into the fluid transportation device 2 through the inlet channel 215. The internal flow is ejected out of the fluid transportation device 2 through the outlet channel 216. The inlet channel 215 is communicated with the inlet branch flow paths 213 (see FIG. 3D). The outlet channel 216 is communicated with the outlet confluent flow paths 214 (see FIG. 3C). After the fluid transportation device is assembled, the inlet branch flow paths 213 are communicated with the surrounding environment through the inlet channel 215, and the outlet confluent flow paths 214 are communicated with the surrounding environment through the outlet channel 216.

Please refer to FIG. 3B and FIG. 3C again. The outlet confluent flow paths 214 that are close to the first surface 211 are outwardly expanded, so that a second buffer zone (i.e. the outlet buffer cavity 2141a) is collectively defined by the valve membrane 222a and 232a that are on the first surface 211. The outlet confluent flow paths 214 that are close to the second surface 212 are outwardly expanded, so that another outlet buffer cavity 2141b is collectively defined by the valve membrane 222b and 232b. As such, the fluid introduced into the first chambers 22a, 23a and the second chambers 22b, 23b can be temporarily stored in the outlet buffer cavities 2141a and 2141b, then smoothly flows into the outlet confluent flow paths 214, and finally ejected out of the fluid transportation device 2 through the outlet channel 216.

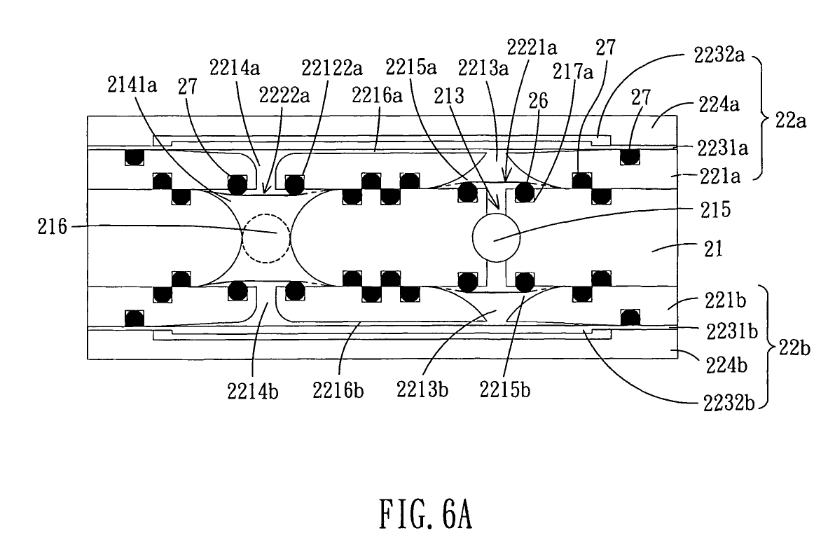

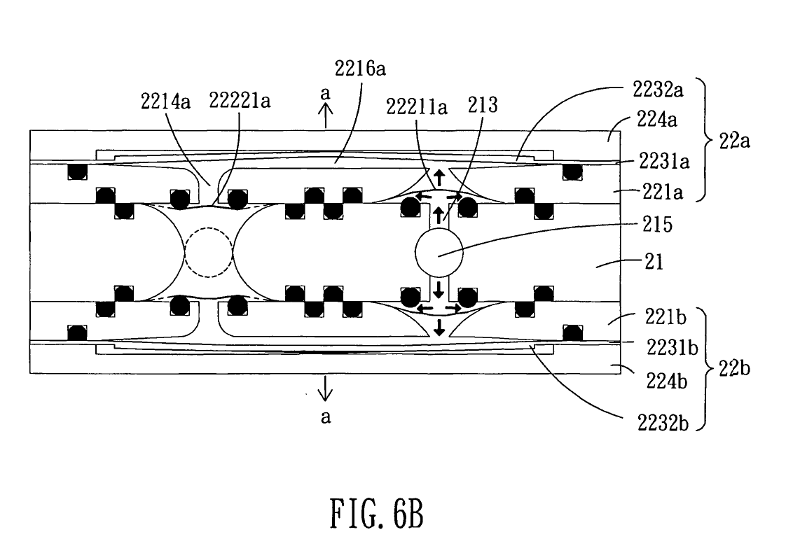

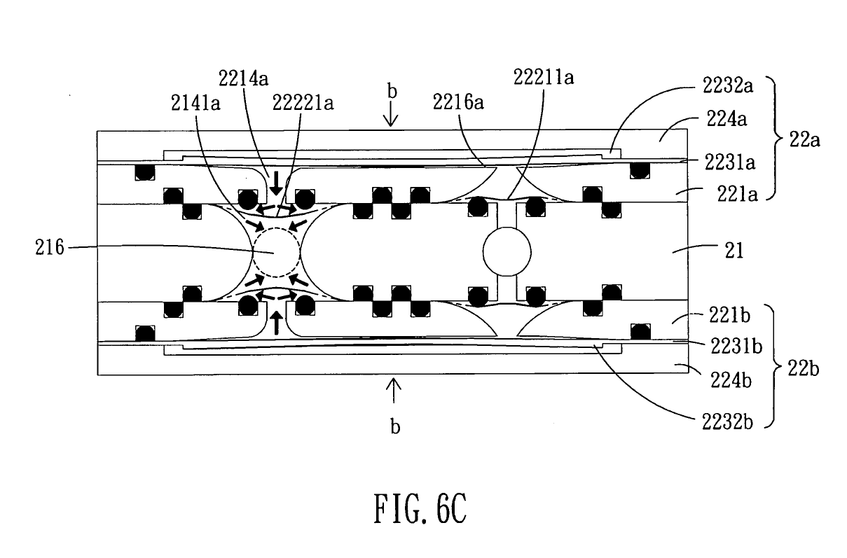

Moreover, several recess structures are formed in the first surface 211 and the second surface 212. The recess structures 217a, 218a, 217b and 218b are arranged in the outer peripheries of the inlet branch flow paths 213 and annularly surround the inlet branch flow paths 213. The recess structures 219a and 219b are arranged in the outer peripheries of the outlet confluent flow paths 214 and annularly surround the outlet confluent flow paths 214. The recess structures 217a, 218a, 219a, 217b, 218b and 219b are used for accommodating corresponding sealing rings 26 (as shown in FIG. 6A).

In this embodiment, the flow-gathering module 21 is made of thermoplastic material. The sealing rings 26 are circular rings made of chemical-resistant and soft material. For example, the sealing rings 26 are rubbery rings that are methanol-resistant or acetic acid-resistant but not limited to the materials listed above.

Please refer to FIG. 2 again. The valve membrane 222a, the valve cap 221a, the actuating member 223a and the cover plate 224a of the first chamber 22a of the first double-chamber actuating structure 22 are stacked on the first surface 211 of the flow-gathering module 21. Likewise, the valve membrane 232a, the valve cap 231a, the actuating member 233a and the cover plate 234a of the first chamber 23a of the second double-chamber actuating structure 23 are stacked on the first surface 211 of the flow-gathering module 21. The valve membrane 222a is arranged between the first surface 211 of the flow-gathering module 21 and the valve cap 221a, and aligned with the flow-gathering module 21 and the valve cap 221a. Likewise, the valve membrane 232a is arranged between the first surface 211 of the flow-gathering module 21 and the valve cap 231a, and aligned with the flow-gathering module 21 and the valve cap 231a. The actuating member 223a is disposed above the valve cap 221a, and comprises a vibration film 2231a and an actuator 2232a. Likewise, the actuating member 233a is disposed above the valve cap 231a, and comprises a vibration film 2331a and an actuator 2332a. When a voltage is applied on the actuating member 223a or 233a, the actuating member 223a or 233a is subject to vibration so as to actuate the fluid transportation device 2. The cover plate 224a and 234a are respectively disposed over the actuating members 223a and 233a for sealing the first chambers 22a and 23a. After the valve membrane 222a, the valve cap 221a, the actuating member 223a and the cover plate 224a are sequentially stacked from bottom to top and fixed on the first surface 211 of the flow-gathering module 21 by a fastening element (not shown), the first chamber 22a of the first double-chamber actuating structure 22 is defined. Likewise, after the valve membrane 232a, the valve cap 231a, the actuating member 233a and the cover plate 234a of the first chamber 23a are sequentially stacked from bottom to top and fixed on the first surface 211 of the flow-gathering module 21 by a fastening element (not shown), the first chamber 23a of the second double-chamber actuating structure 23 is defined. As previously, the second chamber 22b of the first double-chamber actuating structure 22 is disposed on the second surface 212 of the flow-gathering module 21, wherein the first chamber 22a and the second chamber 22b are mirror-symmetrical with respect to the flow-gathering module 21. The second chamber 23b of the second double-chamber actuating structure 23 is disposed on the second surface 212 of the flow-gathering module 21, wherein the first chamber 23a and the second chamber 23b are mirror-symmetrical with respect to the flow-gathering module 21 (see FIGS. 2 and 6A). For clearly describing the fluid transportation device 2, only the first chamber 22a of the first double-chamber actuating structure 22 is illustrated in more details as follows.

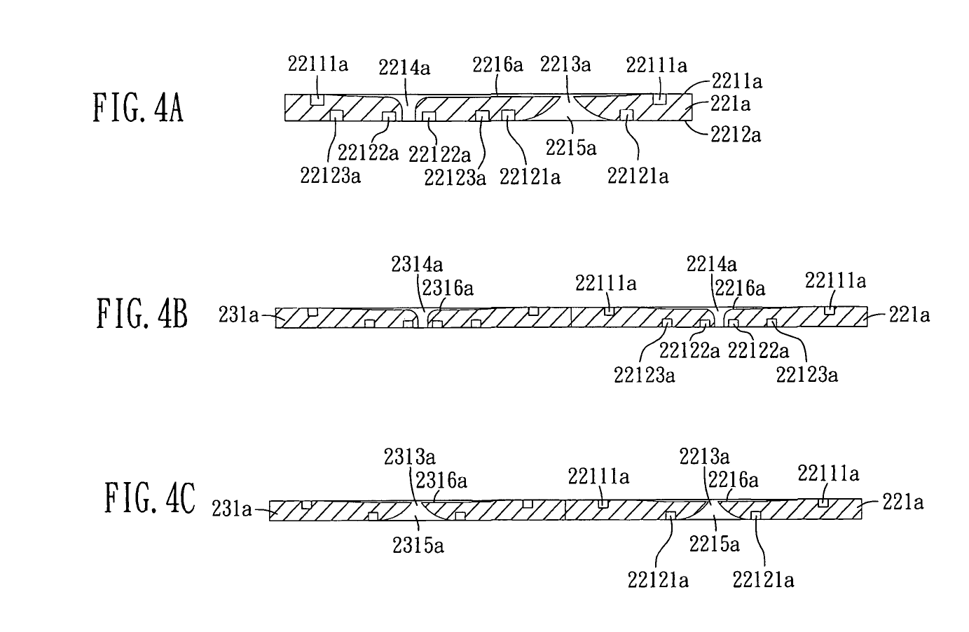

FIG. 4A is a schematic cross-sectional view illustrating the valve cap of the first chamber included in the first double-chamber actuating structure of the fluid transportation device shown in FIG. 3A and taken along the line A-A. FIG. 4B is a schematic cross-sectional view illustrating the valve caps of the first chambers included in the first and second double-chamber actuating structures of the fluid transportation device shown in FIG. 3A and taken along the line C-C. FIG. 4C is a schematic cross-sectional view illustrating the valve caps of the first chambers included in the first and second double-chamber actuating structures of the fluid transportation device shown in FIG. 3A and taken along the line B-B. Please refer to FIGS. 4A, 4B, 4C, 2 and 3A. As shown in FIG. 2, the valve cap 221a of the first chamber 22a of the first double-chamber actuating structure 22 is disposed on the first surface 211 of the flow-gathering module 21. The valve cap 221a has an upper surface 2211a and a lower surface 2212a. The lower surface 2212a faces the first surface 211 of the flow-gathering module 21. The valve membrane 222a is sandwiched between the lower surface 2212a of the valve cap 221a and the first surface 211 of the flow-gathering module 21. The valve cap 221a further comprises a first valve channel and a second valve channel that run through the upper surface 2211a and the lower surface 2212a. In this embodiment, the first valve channel is an inlet valve channel 2213a, and the second valve channel is an outlet valve channel 2214a (see FIGS. 2 and 4B). The inlet valve channel 2213a is aligned with an inlet branch flow path 213. The outlet valve channel 2214a is aligned with the outlet buffer cavity 2141a (see FIGS. 2 and 6). The inlet valve channel 2213a of the valve cap 221a that is close to the lower surface 2212a is outwardly expanded, so that a first buffer zone is collectively defined by the valve cap 221a and the valve membrane 222a. In this embodiment, the first buffer zone is an inlet buffer cavity 2215a, which is concavely formed in the lower surface 2212a of the valve cap 221a and corresponding to the inlet valve channel 2213a. The inlet buffer cavity 2215a is communicated with the inlet valve channel 2213a (see FIGS. 6A and 4C).

Please refer to FIGS. 2 and 6A again. The upper surface 2211a of the valve cap 221a is partially depressed, so that a pressure cavity 2216a is collectively defined by the concave portion of the upper surface 2211a and the actuating member 223a. The pressure cavity 2216a is communicated with the inlet buffer cavity 2215a through the inlet valve channel 2213a (see FIG. 4C). The pressure cavity 2216a is also communicated with the outlet buffer cavity 2141a (see FIG. 4B). Moreover, several recess structures are formed in the valve cap 221a. The recess structures 22121a, 22122a and 22123a are formed in the lower surface 2212a of the valve cap 221a. The recess structure 22121a annularly surrounds the inlet valve channel 2213a. The recess structures 22122a and 22123a annularly surround the outlet buffer cavity 2141a. The recess structure 22111a is formed in the upper surface 2211a of the valve cap 221a. The recess structure 22111a annularly surrounds the pressure cavity 2216a. The recess structures 22121a, 22122a, 22123a and 22111a are used for accommodating corresponding sealing rings 27 (see FIG. 6A). In this embodiment, the valve cap 221a is made of thermoplastic material. In addition, the valve cap 221a and the flow-gathering module 21 are made of the same material. The sealing rings 27 and the sealing rings 26 are made of the same material, and are not redundantly described herein.

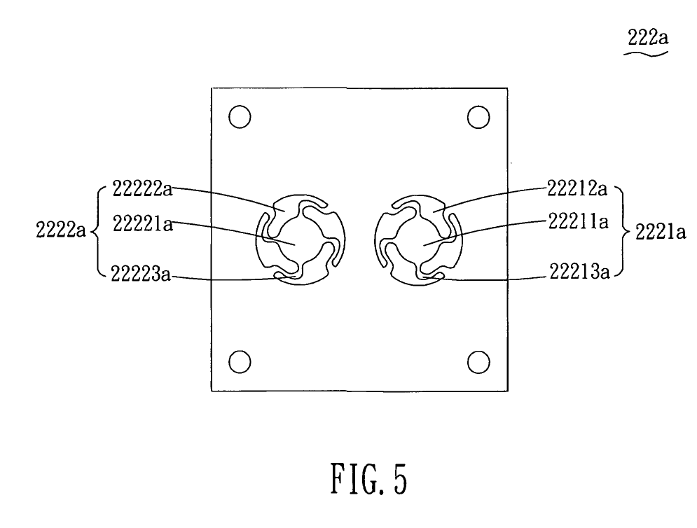

FIG. 5 is a schematic cross-sectional view illustrating the valve membrane of the first chamber included in the first double-chamber actuating structure of the fluid transportation device shown in FIG. 2. Please refer to FIGS. 2, 5 and 6A. The valve membrane 222a is produced by a conventional machining process, a photolithography and etching process, a laser machining process, an electroforming process or an electric discharge machining process. The valve membrane 222a is a sheet-like membrane with substantially uniform thickness and comprises several hollow-types valve switches (e.g. first and second valve switches). In this embodiment, the first valve switch is an inlet valve structure 2221a and the second valve switch is an outlet valve structure 2222a. The inlet valve structure 2221a is aligned with the inlet branch flow path 213 of the flow-gathering module 21, the inlet valve channel 2213a of the valve cap 221a and the inlet buffer cavity 2215a. The outlet valve structure 2222a is aligned with the outlet confluent flow path 214 of the flow-gathering module 21, the outlet buffer cavity 2141a and the outlet valve channel 2214a of the valve cap 221a (see FIG. 6A).

Please refer to FIG. 5. The inlet valve structure 2221a includes an inlet valve slice 22211a and several perforations 22212a formed in the periphery of the inlet valve slice 22211a. In addition, the inlet valve structure 2221a has several extension parts 22213a between the inlet valve slice 22211a and the perforations 22212a. Similarly, the outlet valve structure 2222a comprises an outlet valve slice 22221a, several perforations 22222a and several extension parts 22223a. The configurations and the operation principles of the outlet valve slice 22221a, the perforations 22222a and the extension parts 22223a included in the outlet valve structure 2222a are similar to corresponding components of the inlet valve structure 2221a, and are not redundantly described herein. In this embodiment, the valve membrane 222a is a flexible sheet-like membrane with substantially uniform thickness. The valve membrane 222a is made of excellent chemical-resistant organic polymeric material or metallic material, which includes but is not limited to polyimide (PI), aluminum, nickel, stainless steal, copper, copper alloy or nickel alloy.

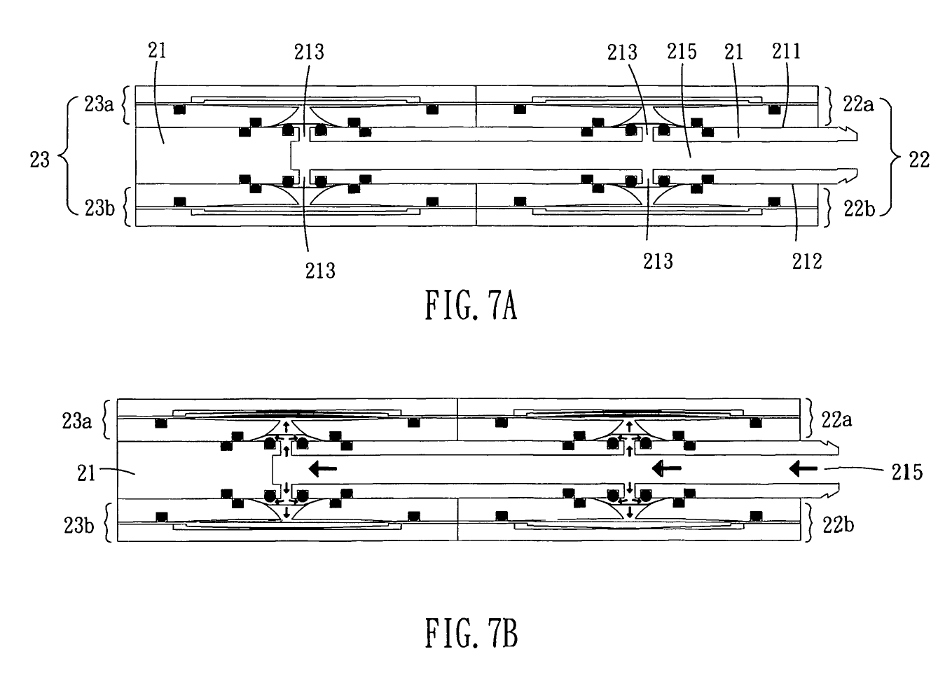

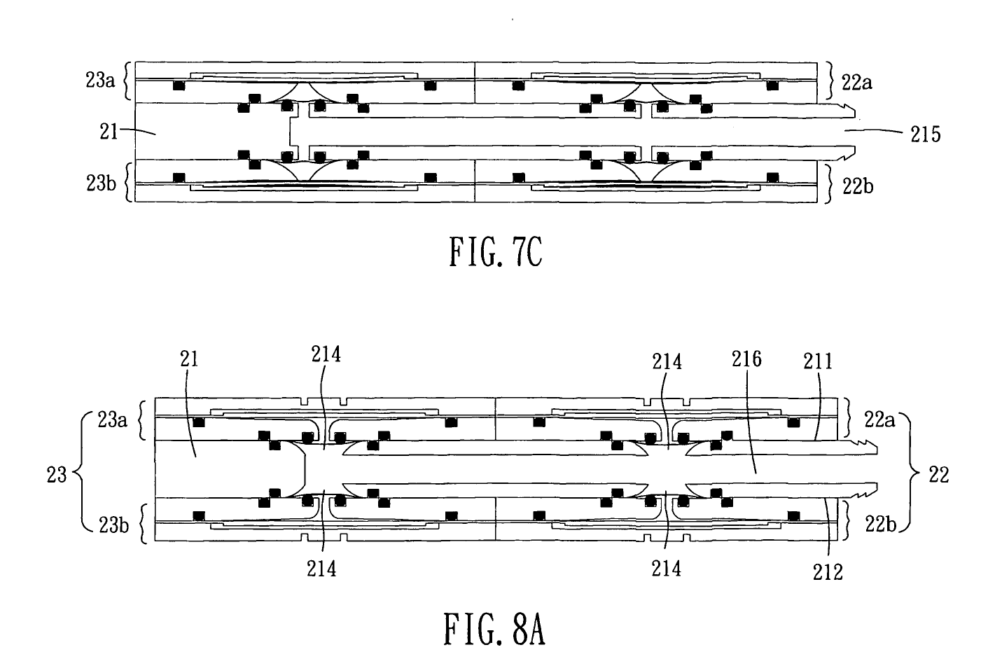

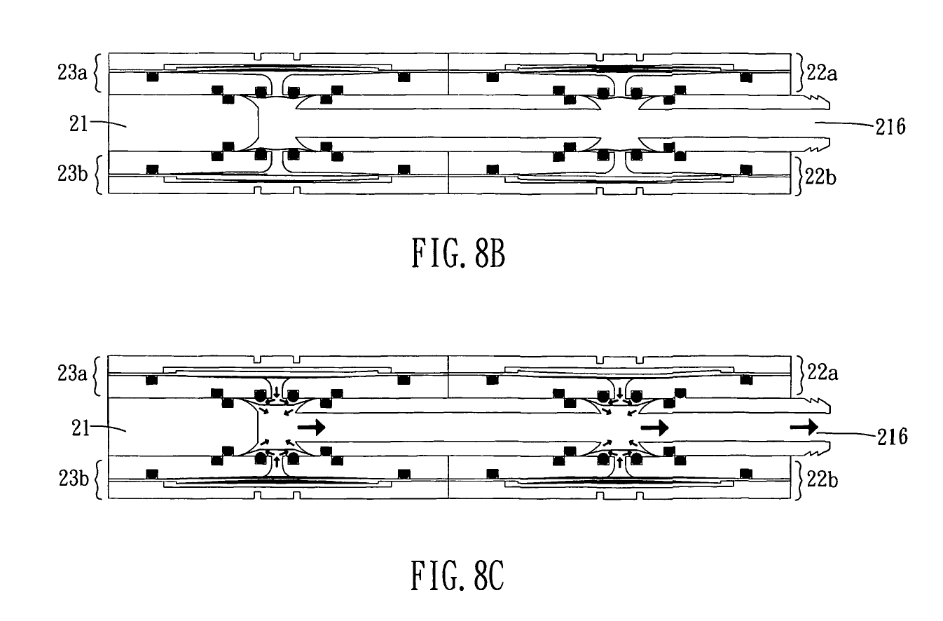

As previously described, the valve membrane 222a is a flexible sheet-like membrane, and the valve membrane 222a is arranged between the first surface 21 of the flow-gathering module 21 and the valve cap 221a. If the volume of the pressure cavity 2216a is expanded to result in suction, the suction will cause the inlet valve structure 2221a and the outlet valve structure 2222a to shift toward the pressure cavity 2216a. Since the inlet valve channel 2213a and the outlet valve channel 2214a have distinguishable structure at the lower surface 2212a of the valve cap 221a (see FIGS. 4A and 6A), a negative pressure difference in the pressure cavity 2216a only causes the inlet valve structure 2221a of the valve membrane 222a to shift toward the valve cap 221a (see FIGS. 6B and 7B). At this moment, the outlet valve structure 2222a is attached on the lower surface 2212a of the valve cap 221a (see FIGS. 6B and 8B), and thus the fluid can only be transported from the flow-gathering module 21 to the valve cap 221a through the perforations 22212a of inlet valve structure 2221a (along the direction indicated as an arrow, see FIGS. 6B and 7B), and then transmitted to the pressure cavity 2216a through the inlet buffer cavity 2215a and the inlet valve channel 2213a. Under this circumstance, the outlet valve structure 2222a is closed, so that the fluid is not returned back.

Similarly, since the inlet branch flow paths 213 and the outlet confluent flow paths 214 have distinguishable structure at the first surface 211 of the flow-gathering module 21 (see FIGS. 2 and 3B), a positive pressure difference in the pressure cavity 2216a causes downward force of the valve membrane 222a. In response to the downward force of the valve membrane 222a, the outlet valve structure 2222a is shifted toward the flow-gathering module 21. At this moment, the inlet valve structure 2221a is attached on the first surface 211 of the flow-gathering module 21 to seal the inlet branch flow paths 213 of the flow-gathering module 21, and thus the inlet valve structure 2221a is closed (see FIGS. 6C and 7C). In other words, the fluid can only be transported from the pressure cavity 2216a to the outlet valve channel 2214a of the flow-gathering module 21 through the perforations 22222a of the outlet valve structure 2222a (see FIGS. 6C and 8C). Under this circumstance, the inlet valve structure 2221a is quickly opened or closed in response to the positive or negative pressure difference in the pressure cavity 2216a, so that the outlet valve structure 2222a is correspondingly opened or closed to control transportation of the fluid and preventing the fluid from being returned back.

Please refer to FIG. 2 again. In the first chamber 22a of the first double-chamber actuating structure 22, the actuating member 223a includes a vibration film 2231a and an actuator 2232a. The actuating member 223a has a periphery fixed on the valve cap 221a, so that the pressure cavity 2216a is collectively defined by the valve cap 221a and the actuating member 223a (see FIG. 6A). The vibration film 221a of the actuating member 223a is a single-layered metallic structure. For example, the vibration film 2231a is made of stainless steel or copper, but not limited to the materials listed above. In some embodiments, the vibration film 2231a is a two-layered structure, which includes a metallic layer and a biochemical-resistant polymeric sheet attached on the metallic layer. The actuator 2232a is attached on the vibration film 2231a. The actuator 2232a is a piezoelectric plate made of highly piezoelectric material such as lead zirconate titanate (PZT). The cover plate 224a is disposed on the actuator 2232a. The valve membrane 222a, the valve cap 221a and the actuating member 223a are clamped between the cover plate 224a and the first surface 211 of the flow-gathering module 21, thereby assembling the first chamber 22a of the first double-chamber actuating structure 22 of the fluid transportation device 2 as shown in FIG. 3A.

Please refer to FIGS. 2, 3A and 6A. FIG. 6A is a schematic cross-sectional view illustrating the fluid transportation device shown in FIG. 3A and taken along the line A-A, wherein the fluid transportation device is in a non-actuation status. The cross-sectional view and the operations of the fluid transportation device taken along the line a-a are similar to those shown in FIG. 6A, and are not redundantly described herein. For brevity, only the fluid transportation device taken along the line A-A is illustrated as follows. After the first chamber 22a of the first double-chamber actuating structure 22 is mounted on the first surface 211 of the flow-gathering module 21, the inlet branch flow path 213 of the flow-gathering module 21 is aligned with the inlet valve structure 2221a of the valve membrane 222a and the inlet buffer cavity 2215a and the inlet valve channel 2213a of the valve cap 221a. At the same time, the outlet confluent flow path 214 of the flow-gathering module 21 is aligned with the outlet buffer cavity 2141a, the outlet valve structure 2222a of the valve membrane 222a and the outlet valve channel 2214a of the valve cap 221a.

As previously described, the recess structure 217a is formed in the first surface 211 of the flow-gathering module 21 and annularly surrounds the inlet branch flow path 213. Since the thickness of the sealing ring 26 accommodated in the recess structure 217a is greater than the depth of the recess structure 217a, the sealing ring 26 is partially protruded out of the recess structure 217a to form a convex structure. Under this circumstance, the inlet valve slice 22211a of the inlet valve structure 2221a of the valve membrane 222a is raised. The convex structure is sustained against the valve membrane 222a to provide a pre-force on the inlet valve structure 2221a. The pre-force results in a stronger sealing effect to prevent the fluid from being returned back. In addition, due to the convex structure, a gap is formed between the inlet valve structure 22211a and the first surface 211 of the flow-gathering module 21. The gap is helpful for opening the inlet valve structure 2221a during the fluid enters the gap. Similarly, after the sealing ring 27 is accommodated in the recess structure 22122a that is formed in the lower surface 2212a of the valve cap 221a and annularly surrounds the outlet buffer cavity 2141a, the sealing ring 27 is partially protruded out of the recess structure 22122a to form a convex structure. As such, the outlet valve structure 2222a of the valve membrane 222a is downwardly raised with respect to the valve cap 221a, and a gap is formed between the outlet valve slice 22221a and the lower surface 2212a of the valve cap 221a. The convex structures of the outlet valve structure 2222a and the inlet valve structure 2221a are arranged on opposite sides of the valve membrane 222a. The functions of the convex structure of the outlet valve structure 2222a are similar to that of the inlet valve structure 2221a, and are not redundantly described herein. As mentioned above, the convex structures are defined by the recess structures (217a, 22122a ) and corresponding sealing rings (26, 27). Alternatively, the convex structures may be directly formed on the flow-gathering module 21 and the valve cap 221a by a semiconducting fabricating method such as a photolithography and etching process, an electroplating process or an electroforming process. Alternatively, the convex structures may be integrally formed with the flow-gathering module 21 and the valve cap 221a by ejecting thermoplastic material. The remainder of the valve membrane 222a is attached between the valve cap 221a and the flow-gathering module 21. The sealing rings 26 and 27 received in the recess structures 218a, 219a, 22121a, 22123a and 22111a may facilitate close contact between the valve membrane 222a, the valve cap 221a and the flow-gathering module 21, thereby avoiding fluid leakage.

Please refer to FIG. 6A again. The valve cap 221b, the valve membrane 222b, the actuating member 223b and the cover plate 224b of the second chamber 22b of the first double-chamber actuating structure 22 are disposed on the second surface 212 of the flow-gathering module 21. The first chamber 22a and the second chamber 22b are mirror-symmetrical with respect to the flow-gathering module 21. The configurations and functions of the second chamber 22b are identical to those of the first chamber 22a. The configurations and functions of the first chamber 23a and the second chamber 23b of the second double-chamber actuating structure 23 are identical to those of the first chamber 22a and the second chamber 22b of the first double-chamber actuating structure 22. For brevity, the fluid transportation process is illustrated by referring to the first chamber 22a of the first double-chamber actuating structure 22. It is of course that the second chamber 22b and the first chamber 22a of the first double-chamber actuating structure 22 and the second chamber 23b and the first chamber 23a of the second double-chamber actuating structure 23 are synchronously actuated to transport the fluid.

FIG. 6B is a schematic cross-sectional view illustrating the fluid transportation device of the present invention, in which the volume of the pressure cavity shown in FIG. 6A is expanded. Take the first chamber 22a for example. When a voltage is applied on the actuator 2232a, the actuating member 223a is deformed in the direction “a” and thus the volume of the pressure cavity 2216a is expanded to result in a negative pressure difference and a suction. Due to the negative pressure difference and the suction, the inlet valve structure 2221a and the outlet valve structure 2222a of the valve membrane 222a are uplifted. Since the inlet valve structure is aligned with the inlet buffer cavity 2215a, the inlet valve slice 22211a is quickly opened in response to the pre-force provided by the recess structure 217a and the sealing ring 26 (see FIGS. 6B and 7B). As such, a great amount of fluid is introduced into the inlet channel 215 of the flow-gathering module 21 and then branched by the inlet branch flow paths 213. As such, the fluid is transported into the first chamber 22a, and then transported to the pressure cavity 2216a through the perforations 22212a of the inlet valve structure 2221a of the valve membrane 222a and the inlet buffer cavity 2215a and inlet valve channel 2213a of the valve cap 221a. At this moment, the pulling force exerted on the outlet valve structure 2222a of the valve membrane 222a and the pulling force exerted on the inlet valve structure 2221a are in the same direction. In addition, the outlet valve structure 2222a close to the lower surface 2212a of the valve cap 221a and the inlet valve structure 2221a close to the lower surface 2212a of the valve cap 221a have different structures. The sealing ring 27 accommodated in the recess structure 22122a provides a pre-sealing effect. The pulling force exerted on the outlet valve structure 2222a of the valve membrane 222a causes the outlet valve slice 22221a to seal the outlet valve channel 2214a, and thus the fluid will not be returned back (see FIGS. 6B and 8B).

In a case that the direction of the electric field applied on the actuator 2232a is changed such that the actuator 242 is subject to deformation in the direction “b” (see FIG. 6C), the actuating member 223a is deformed toward the flow-gathering module 21 to compress the pressure cavity 2216a. As such, the volume of the pressure cavity 2216a is shrunk to result in a positive pressure difference from the surrounding environment. In response to the positive pressure difference, an impulse is applied on the fluid within the pressure cavity 2216a. Due to the impulse, a great amount of fluid is instantly exhausted out of the pressure cavity 2216a through the outlet valve channel 2214a. At the same time, the impulse generated from the positive pressure difference of the pressure cavity 2216a and in the direction toward the flow-gathering module 21 is also exerted on the inlet valve structure 2221a and the outlet valve structure 2222a of the valve membrane 222a. As such, a pre-force will quickly open the outlet valve slice 22221a of the outlet valve structure 2222a. When the outlet valve slice 22221a is opened, the fluid in the pressure cavity 2216a is transported to the outlet buffer cavity 2141a and the outlet confluent flow paths 214 through the outlet valve channel 2214a of the valve cap 221a and the perforations 22222a of the outlet valve structure 2222a of the valve membrane 222a (see FIGS. 6C and 8C), and then exhausted out of the fluid transportation device through the outlet channel 216. Meanwhile, a fluid transporting cycle is completed.

On the other hand, the inlet branch flow path 213 close to the first surface 211 of the flow-gathering module 21 and the outlet confluent flow path 214 close to the first surface 211 of the flow-gathering module 21 have different structures. In addition, the sealing ring 26 provides a pre-sealing effect. As such, when the impulse in the direction toward the flow-gathering module 21 is exerted on the inlet valve structure 2221a, the inlet valve structure 2221a is pressed down to its closed position by the inlet valve slice 22211a, and thus the inlet branch flow path 213 is sealed (see FIGS. 6C and 7C). At this moment, no fluid is allowed to flow through the inlet valve structure 2221a and thus the fluid will not be returned back.

In a case that the actuator 2232a is subject to upward deformation due to a voltage applied thereon, the volume of the pressure cavity 2216a is expanded. As such, the fluid is transported from the inlet buffer cavity 2215a into the pressure cavity 2216a through the inlet valve channel 2213a. In a case that the actuating member 223a is subject to downward deformation, the volume of the pressure cavity 2216a is shrunk and thus the fluid is exhausted out of the pressure cavity 2216a. That is, by changing the direction of the electric field applied on the actuating member 223a is changed, the actuating member 223a is moved in a reciprocating manner, so that the fluid transportation device 2 is capable of pumping and releasing the fluid and achieving the purpose of transporting the fluid.

Please refer to FIGS. 7A˜7C and FIGS. 8A˜8C. FIG. 7A is a schematic cross-sectional view illustrating the fluid transportation device shown in FIG. 3A and taken along the line B-B. FIG. 8A is a schematic cross-sectional view illustrating the fluid transportation device shown in FIG. 3A and taken along the line C-C. As shown in FIG. 7A, the inlet channel 215 is a pipeline between the first surface 211 and the second surface 212 of the flow-gathering module 21. The external flow is introduced into the fluid transportation device 2 through the inlet channel 215. The inlet channel 215 is communicated with the multiple inlet branch flow paths 213, so that the fluid is transported though the inlet branch flow paths 213 to the first chamber 22a and the second chamber 22b of the first double-chamber actuating structure 22 and the first chamber 23a and the second chamber 23b of the second double-chamber actuating structure 23. As shown in FIG. 8A, the outlet channel 216 is a pipeline between the first surface 211 and the second surface 212 of the flow-gathering module 21. The internal flow is ejected out of the fluid transportation device 2 through the outlet channel 216. The outlet channel 216 is communicated with the multiple outlet confluent flow paths 214, so that the fluid from the first chamber 22a and the second chamber 22b of the first double-chamber actuating structure 22 and the first chamber 23a and the second chamber 23b of the second double-chamber actuating structure 23 is exhausted out of the fluid transportation device 2 through the outlet channel 216.

Please refer to FIGS. 7B and 8B. As shown in FIG. 7B, when the fluid is introduced into the inlet channel 215, a portion of fluid is firstly transported to the first chamber 22a and the second chamber 22b of the first double-chamber actuating structure 22 through a first inlet branch flow path 213, and then transported to the first chamber 23a and the second chamber 23b of the second double-chamber actuating structure 23 through a second inlet branch flow path 213. If the fluid transportation device 2 has three or more double-chamber actuating structures, the rest may be deduced by analogy.

When the actuators includes in the first chamber 22a and the second chamber 22b of the first double-chamber actuating structure 22 and the first chamber 23a and the second chamber 23b of the second double-chamber actuating structure 23 are vibrated at the same frequency, all actuating members are externally raised. As such, all inlet valve structures are opened and the fluid is pumped into the chambers (see FIG 7B). At the same time, all outlet valve structures are more tightly closed (see FIG. 8B), and thus the fluid will not be returned back.

Please refer to FIGS. 7C and 8C. When the actuators includes in the first chamber 22a and the second chamber 22b of the first double-chamber actuating structure 22 and the first chamber 23a and the second chamber 23b of the second double-chamber actuating structure 23 are vibrated at the same frequency, all actuating members are internally concaved to compress the pressure cavity to result in a positive pressure difference. As such, all outlet valve structures are opened and the fluid to discharge the fluid (see FIG. 8C). At the same time, all inlet valve structures are more tightly closed (see FIG. 7C), and thus the fluid will not be returned back. The detail operations have been described in FIG. 6, and are not redundantly described herein.

From the above description, the fluid transportation device of the present invention includes a flow-gathering module and multiple double-chamber actuating structures. The multiple double-chamber actuating structures are symmetrically stacked on the flow-gathering module. For assembling the fluid transportation device, two sets of valve membranes, valve caps and actuating members are respectively stacked on the first and second surfaces of the flow-gathering module, thereby forming a double-chamber actuating structure with two mirror-symmetrical chambers. Next, multiple double-chamber actuating structures are successively arranged on the fluid transportation device in a side-by-side manner. As a consequence, the double-chamber actuating structures are horizontally expanded. In comparison with the conventional micro pump with multiple single-chamber structures, the fluid transportation device of the present invention has increased flow rate and head. In addition, the fluid transportation device of the present invention has reduced overall volume, thereby meeting the miniaturization demand.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A fluid transportation device having multiple double-chamber actuating structures for transporting a fluid, said fluid transportation device comprising:
a flow-gathering module comprising two surfaces opposed to each other, multiple first flow paths and multiple second flow paths running through said two surfaces, an inlet channel arranged between said two surfaces and communicated with said multiple first flow paths, and an outlet channel arranged between said two surfaces and communicated with said multiple second flow paths; and
multiple double-chamber actuating structures arranged on said flow-gathering module side by side, wherein each double-chamber actuating structure includes a first chamber and a second chamber symmetrically arranged on said two surface of said flow-gathering module, and each of said first chamber and said second chamber includes a valve cap arranged over said flow-gathering module and having a first valve channel and a second valve channel, a valve membrane arranged between said flow-gathering module and said valve cap, and an actuating member having a periphery fixed on said valve cap.

2. The fluid transportation device having multiple double-chamber actuating structures according to claim 1 wherein said valve membrane includes a first valve structure and a second valve structure corresponding to said first flow path and said second flow path, respectively.

3. The fluid transportation device having multiple double-chamber actuating structures according to claim 2 wherein a first buffer zone is arranged between said valve membrane and said valve cap, and a second buffer zone is arranged between said valve membrane and said flow-gathering module.

4. The fluid transportation device having multiple double-chamber actuating structures according to claim 3 wherein said first valve structures, said first buffer zones and said first valve channels of said first chamber and said second chamber are aligned with said first flow path of said flow-gathering module, and said second buffer zones, said second valve structures and said second valve channels of said first chamber and said second chamber are aligned with said second flow path of said flow-gathering module.

5. The fluid transportation device having multiple double-chamber actuating structures according to claim 1 wherein said actuating member and said valve cap collectively define a pressure cavity.

6. The fluid transportation device having multiple double-chamber actuating structures according to claim 1 wherein said fluid includes a gas and a liquid.

7. The fluid transportation device having multiple double-chamber actuating structures according to claim 1 wherein said actuating member includes an actuator and a vibration film.

8. The fluid transportation device having multiple double-chamber actuating structures according to claim 1 wherein said first flow paths are inlet branch flow paths, and said second flow paths are outlet confluent flow paths.

9. The fluid transportation device having multiple double-chamber actuating structures according to claim 1 wherein said actuating members included in said first chambers and said second chambers of said multiple double-chamber actuating structures are vibrated at the same frequency.
